(19) United States
(12) Patent Application Publication
(10) Pub. No.: US 2026/0105426 A1
(43) Pub. Date: Apr. 16, 2026

(54) COMPUTER-IMPLEMENTED METHODS, SYSTEMS COMPRISING COMPUTER-READABLE MEDIA, AND ELECTRONIC DEVICES FOR COMPUTATIONALLY EFFICIENT, HIGH DIMENSIONALITY DIGITAL INTERACTION OPTIMIZATION

(71) Applicant: Mastercard International Incorporated, Purchase, NY (US)

(72) Inventors: Nick Baguley, Salt Lake City, UT (US); Justin Harnish, Salt Lake City, UT (US)

(73) Assignee: Mastercard International Incorporated, Purchase, NY (US)

(21) Appl. No.: 18/916,592

(22) Filed: Oct. 15, 2024

(51) Int. Cl. G06Q 20/10

(52) U.S. Cl. CPC G06Q 20/102

(57) ABSTRACT

Computer-implemented method for digital interaction optimization that includes: receiving an input signal for a present digital interaction; retrieving stored value functions corresponding to previous digital interactions having a matching use case to the present digital interaction, each of the stored value functions including stored data values for a plurality of parameters; generating a present value function based at least in part on present data values for the plurality of parameters, the present data values being extracted from the input signal; evaluating the present value function against each of the stored value functions to generate corresponding outputs; determining, based on at least one of the outputs, a preferred value for one or more of the parameters; and executing a subsequent digital interaction having the matching use case based on the preferred value.

### FIELD OF THE INVENTION

The present disclosure generally relates to computer-implemented methods, systems comprising computer-readable media, and electronic devices for computationally efficient digital interaction capture in high dimensional spaces and, more particularly, to systems and methods for performing such capture to support model analyses.

### BACKGROUND

Existing methods for automated analysis of digital interactions-for example, potential or actual financial transactions—include resource-intensive computational models and methods. Moreover, such methods are relatively deterministic with respect to captured and modeled datapoints. Yet with the amount of available data increasing simultaneously with the size and complexity of such models, such computational and resource burdens are often prohibitive.

A more efficient method for high-dimensional automated analyses and optimization is needed.

This background discussion is intended to provide information related to the present invention which is not necessarily prior art.

### BRIEF SUMMARY

Embodiments of the present technology relate to computer-implemented methods, systems comprising computer-readable media, and electronic devices for computationally efficient digital interaction capture in high dimensional spaces and, more particularly, to systems and methods for performing such capture to support model analyses. Embodiments of the present invention implement technological mechanisms for automated self-referential learning. Embodiments also provide for improved, efficient capture of granular, low-level interaction data and self-learning supporting automated decisioning without prohibitive computational constraints.

More particularly, in an aspect, non-transitory computer-readable storage media having computer-executable instructions stored thereon for digital interaction optimization are provided. The instructions, when executed by one or more processors, cause the one or more processors to: receive an input signal for a present digital interaction; retrieve stored value functions corresponding to previous digital interactions having a matching use case to the present digital interaction, each of the stored value functions including stored data values for a plurality of parameters; generate a present value function based at least in part on present data values for the plurality of parameters, the present data values being extracted from the input signal; evaluate the present value function against each of the stored value functions to generate corresponding outputs; determine, based on at least one of the outputs, a preferred value for one or more of the parameters; and execute a subsequent digital interaction having the matching use case based on the preferred value. The instructions may instruct the one or more processors to perform additional, less, or alternate operations, including those discussed elsewhere herein.

Further, in another aspect, a computer-implemented method for digital interaction optimization may be provided. The method may include: receiving an input signal for a present digital interaction; retrieving stored value functions corresponding to previous digital interactions having a matching use case to the present digital interaction, each of the stored value functions including stored data values for a plurality of parameters; generating a present value function based at least in part on present data values for the plurality of parameters, the present data values being extracted from the input signal; evaluating the present value function against each of the stored value functions to generate corresponding outputs; determining, based on at least one of the outputs, a preferred value for one or more of the parameters; and executing a subsequent digital interaction having the matching use case based on the preferred value. The method may include additional, less, or alternate actions, including those discussed elsewhere herein.

Advantages of these and other embodiments will become more apparent to those skilled in the art from the following description of the exemplary embodiments which have been shown and described by way of illustration. As will be realized, the present embodiments described herein may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

FIG. 1 illustrates various components, in block schematic form, of an exemplary system for digital interaction optimization in accordance with embodiments of the present invention;

FIGS. 2, 3 and 4 illustrate various components of exemplary computing devices shown in block schematic form that may be used with the system of FIG. 1; and

FIG. 5 illustrates at least a portion of the steps of an exemplary computer-implemented method for digital interaction optimization in accordance with embodiments of the present invention.

The Figures depict exemplary embodiments for purposes of illustration only. One skilled in the art will readily recognize from the following discussion that alternative embodiments of the systems and methods illustrated herein may be employed without departing from the principles of the invention described herein. cl DETAILED DESCRIPTION

Existing methods for automated analysis of digital interactions-for example, potential or actual financial transactions—include resource-intensive computational models and methods. Moreover, such methods are relatively deterministic with respect to captured and modeled datapoints. Yet with the amount of available data increasing simultaneously with the size and complexity of such models, such computational and resource burdens are often prohibitive.

Embodiments of the present technology relate to computer-implemented methods, systems comprising computer-readable media, and electronic devices computationally efficient digital interaction capture in high dimensional spaces and, more particularly, to systems and methods for performing such capture to support model analyses. Embodiments of the present invention implement technological mechanisms for self-referential learning. Embodiments also provide for improved, efficient capture of granular, low-level interaction data and self-learning supporting automated decisioning without prohibitive computational constraints.

Preferred embodiments utilize Hamiltonian value functions for self-referential learning to promote efficient capture of relationships at granular levels of detail-such as where the input signal includes data regarding data packets at the internet protocol level-through enabling simple set difference and symmetric difference operations for abstracted representations of data. For example, in one or more embodiments, outputs or policies stored according to and/or embodying such Hamiltonians may be compared one to another, across multiple use cases and/or in a Hilbert Space, and/or fed as input to machine learning models for optimization of one or more digital interaction parameters. In one or more embodiments, the Hamiltonians may each comprise a Hamilton-Jacobi-Bellman equation.

### EXEMPLARY SYSTEM

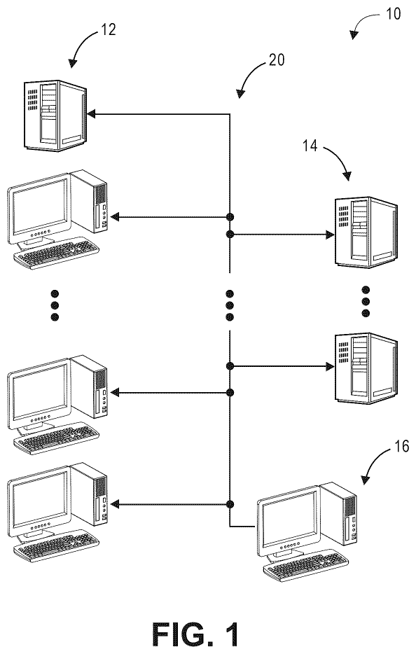

FIG. 1 depicts an exemplary environment 10 for optimizing digital interactions according to embodiments of the present invention. The environment 10 may include a plurality of user devices 12, a plurality of servers 14, a service device 16, and a communication network 20. The user devices 12, plurality of servers 14, and service device 16 may be within or comprise a payment network, such as where user devices 12 correspond to cardholder devices and merchant devices, servers 14 correspond to issuers or issuing banks and acquirers, and service device(s) 16 correspond to a payment processor.

Wherever the environment 10 corresponds to a payment network, a cardholder may have access to a user device 12 through which the cardholder may perform a payment transaction with a merchant having access to another user device 12. The payment network, discussed in more detail below, may process the corresponding digital interaction comprising a putative or completed transaction in conjunction with an issuer and, optionally, an acquirer.

In one or more embodiments, a payment card system of the environment 10 may be implemented via one or more of the service device(s) 16, such as a payment system using the MASTERCARD® interchange network. (MASTERCARD is a registered trademark of Mastercard International Incorporated). The MASTERCARD® interchange network is a set of proprietary communications standards promulgated by Mastercard International Incorporated for the exchange of financial transaction data and the settlement of funds between financial institutions that are members of the Mastercard International Incorporated interchange network. Embodiments described herein may also relate to digital payment services offered under MASTERPASS® by Mastercard International Incorporated or another digital wallet service for a mobile device such as a smartphone.

Other aspects of the environment 10 that may, in one or more embodiments, be implemented by one or more services device(s) 16 may include an open banking service such as that offered under the registered mark FINICITY® of Finicity Corporation as of the initial filing date of the present disclosure. Such features may include, without limitation, features for and comprising an open banking platform configured to manage cardholder payments, gain insight into spending trends and recommendations, manage finances and otherwise direct customary open banking functions.

For example, in one or more embodiments, the one or more of the service device(s) 16 is/are configured to enable merchant or issuer access to banking records and account data of a putative payee, to retrieve and/or enable access to the account data, and/or perform other functions associated with open banking.

More particularly, data subjects (e.g., consumers and businesses seeking financial services from financial service providers) may subscribe for the open banking services, and identify one or more financial accounts or data/documents sources from which to share data and/or directly provide copies of financial and identification information (e.g., access credentials) and documents. The data subjects may also consent to controlled sharing of such financial, identity-and/or location-related information with the open banking services of the service device 16 and, in turn, with consented data recipients (e.g., the financial service providers).

In turn, data recipients (e.g., lenders, credit score agencies, credit card service providers, or other financial institutions or financial service providers) may subscribe and access the open banking services and subject data, for example to calculate credit scores, open new financial accounts, provide advice about improving credit scores, approve loan requests from data subjects, and perform other financial services.

Each of these putative or completed financial transactions, account or data access events, or other open banking operations, may comprise a digital interaction without departing from the spirit of the present invention.

Returning to examples that include a traditional payment processing system more generally, a financial institution, such as an issuing bank or issuer operating a server 14, issues a payment account, such as a credit card account or a debit card account, to the cardholder operating a user device 12, who uses the payment account (or payment card associated with the payment account) to tender payment for a purchase from the merchant operating another user device 12 (e.g., including a payment terminal) and/or a web server 14. To accept payment from the cardholder, the merchant must normally establish an account with a financial institution that is part of the system. This financial institution is usually called a “merchant bank,” an “acquiring bank,” or simply an “acquirer,”which in turn may operate a server 14.

The payment processing system of one or more embodiments may be configured to process authorization messages, such as ISO® 8583 compliant messages and ISO® 20022 compliant messages. (ISO is a registered trademark of the International Organization for Standardization of Geneva, Switzerland.) As used herein, ISO refers to a series of standards approved by the International Organization for Standardization. ISO 8583 compliant messages are defined by the ISO 8583 standard, which governs financial transaction card-originated messages and further defines acceptable message types, data elements, and code values associated with such financial transaction card originated messages. ISO 8583 compliant messages include a plurality of specified locations for data elements. ISO 20022 compliant messages are defined by the ISO 20022 standard. ISO 20022 compliant messages may include acquirer to issuer card messages (ATICA).

In a typical transaction, when the cardholder tenders payment for a purchase (e.g., with a payment card, virtual card, digital wallet, etc.), the merchant requests authorization via the acquirer (and its associated computers) for the amount of the purchase.

In some embodiments, the payment card transaction is a card present transaction conducted, for example, where the cardholder swipes or dips a payment card at the merchant's point-of-sale (POS) terminal. Accordingly, the request is oftentimes performed through the use of the POS terminal. The POS terminal reads the cardholder's account information from the payment card or digital wallet and communicates electronically with the transaction processing computers of the acquirer.

Alternatively, the payment card transaction may be a card-not-present transaction conducted, for example, with a payment card stored on file with the merchant or stored as digital wallet data in a digital wallet on a user's device 12. The device 12 may be, for example, a cellular telephone (e.g., smartphone), a smart watch or other electronic wearable apparel, a tablet, an implanted smart device, a personal computing device, or any other electronic device capable of two-way digital communications which may be associated with a cardholder or account owner.

Using the payment network (or payment processor), computers of the acquirer or the merchant processor will communicate with computers of the issuing bank or issuer to determine whether the cardholder's account is in good standing and whether the purchase amount is covered by the cardholder's available credit line or account balance. Based on these determinations, the request for authorization will be declined or accepted. If the request is accepted, the transaction is given a bank network reference number, such as the Banknet Reference Number, an authorization code, and/or other transaction identifiers that may be used to identify the transaction.

In each case, the signals between devices in connection with open banking and/or putative or completed financial transactions discussed above may individually or in groups or subgroups comprise an “input signal,” discussed in more detail below. For example, any signal associated with a putative transaction—regardless of whether the transaction is completed—may be an “input signal” within the scope of the present invention. as discussed in more detail below, multiple input signals taken at various times or states during the progression of a single transaction or attempted transaction may correspond to multiple distinct input signals.

Moreover, it should be noted that such input signals may include or comprise more granular data gathering below the level of ISO messages or the like with their corresponding structured data fields. For example, in one or more embodiments, data packets captured at the internet protocol level of data abstraction and/or internet protocol addresses, application programming interface (API) calls (e.g., GET, POST, PUT, PATCH, DELETE or the like), and other low level signals may themselves comprise input signals according to one or more embodiments.

However, it is also foreseen that digital interactions other than or in addition to those related to financial transactions are also within the scope of the present invention. For example, in one or more embodiments an online user will interact (e.g., via a user device 12) with another and/or with online content (again, e.g., associated with another user device 12) via a social media website or the like (e.g., hosted by a server 14). It is foreseen that such a digital interaction may also be subject to or described by one or more value relationships, and interactions of that type may be judged along one or more trajectories relative to an optima, such as where, from the individual user's perspective or set of interests, one or more aspects of the interaction may improve or reduce the user's social prospects. Accordingly, the posting of a comment, emoji, or other interaction may be captured in one or more signals which may be or comprise input signal(s) without departing from the spirit of the present invention.

It should be appreciated that a wide variety of digital interaction optimizations are within the scope of the present invention, particularly where such digital interactions have aspects, dimensions or parameters subject to self-referential learning processes incorporating one or more objective functions to optimize parameters with computational efficiency. For example, such self-referential learning processes may rely on Hamiltonian value functions of the same or similar construction, including with the same or similar parameters and objective function, which reference and are evaluated one against the others, enabling recursive learning about the system(s) and event(s) modeled by those value functions.

Returning now to discussion of FIG. 1, the communication network 20 may be partly or entirely internal to an organization or group of affiliated entities, for example where the servers 14 manage databases of and/or provide cloud-based services to and under the management of an organization whose users utilize user devices 12. Also or alternatively, the user devices 12 may access the servers 14 via transmissions, at least in part, across public/semi-public telecommunication network infrastructure, with the communication network 20 being at least in part comprised of such public/semi-public telecommunication network infrastructure.

All or some of the user devices 12 and servers 14, and/or all or some of the virtual resources managed thereby, may at least partly comprise a secure network computing environment. Alternatively or in addition, the user devices 12 and servers 14 may manage access to the user devices 12 and servers 14 under an authentication management framework.

In one or more embodiments, the user devices 12 and service device(s) 16 may comprise desktops, laptops, cellular telephones (e.g., smartphones), smart watches or other electronic wearable apparel, tablets, implanted smart devices, or any other electronic device or other computing devices. In one or more embodiments, the servers 14 may comprise cloud servers, domain controllers, application servers, database servers, database web servers, file servers, mail servers, catalog servers or the like, or combinations thereof. However, it should be appreciated that the types of computing devices attributed to either user devices 12 or servers 14 may be interchangeable and are not limiting. More particularly, a user device 12 may be a server, and a personal computing device may be substituted to perform functions of a server, it being understood that the form of hardware chosen for each such computing device may vary according to the demands of particular embodiments without departing from the spirit of the present invention.

User devices 12 and service device(s) 16 may each respectively include a processing element 22, 60, a memory element 24, 62, and circuitry capable of wired and/or wireless communication with the communication network 20, including, for example, a transceiver or communication element 26, 64. Each of the user devices 12 may additionally include a screen display 27, which may comprise a user interface of the user device 12. The display 27 may include video devices of any of the following types: plasma, standard or ultra-high-definition light-emitting diode (LED), organic LED (OLED), quantum dot LED (QLED), Light Emitting Polymer (LEP) or Polymer LED (PLED), liquid crystal display (LCD), thin film transistor (TFT) LCD, LED side-lit or back-lit LCD, or the like, or combinations thereof. The display 27 may possess a square or a rectangular aspect ratio and may be viewed in either a landscape or a portrait mode. In various embodiments, the display 27 may also include a touch screen occupying all or part of the screen.

Further, each of the user devices 12 and the service device(s) 16 may include a software application or program 28, 66 configured with instructions for performing and/or enabling performance of at least some of the steps set forth herein. In an embodiment, the software programs 28, 66 each comprises instructions stored on computer-readable media of memory element 24.

The servers 14 generally receive requests and queries for data and provision of services and resources from the user devices 12 and/or service device(s) 16, and expose or otherwise provide such data, services and resources. In one or more embodiments, the service device 16 enrolls all or some of the user devices 12 and servers 14 and/or the resources embodied thereby collectively for collection of input signals and/or stored outputs and policies, and for storage of such outputs and policies, in each case as discussed in more detail below.

Generally, each server 14 may include a memory element 48, a processing element 52, a communication element 56, and a software program 58.

The communication network 20 generally allows communication between the user devices 12, the servers 14, and the service device 16, for example in conjunction with creating and transmitting input signals, as well as in connection with analyzing the signals to determine preferred parameter values and store outputs of self-referential learning such as policies, in each case as discussed in more detail below.

The communication network 20 may include the Internet, cellular communication networks, local area networks, metro area networks, wide area networks, cloud networks, plain old telephone service (POTS) networks, and the like, or combinations thereof. The communication network 20 may be wired, wireless, or combinations thereof and may include components such as modems, gateways, switches, routers, hubs, access points, repeaters, towers, and the like. The user devices 12 and/or servers 14 may, for example, connect to the communication network 20 either through wires, such as electrical cables or fiber optic cables, or wirelessly, such as RF communication using wireless standards such as cellular 2G, 3G, 4G or 5G, Institute of Electrical and Electronics Engineers (IEEE) 802.11 standards such as WiFi, IEEE 802.16 standards such as WiMAX, Bluetooth™, or combinations thereof.

The communication elements 26, 56, 64 generally allow communication between the user devices 12, the servers 14, the service device 16 and/or the communication network 20. The communication elements 26, 56, 64 may include signal or data transmitting and receiving circuits, such as antennas, amplifiers, filters, mixers, oscillators, digital signal processors (DSPs), and the like. The communication elements 26, 56, 64 may establish communication wirelessly by utilizing radio frequency (RF) signals and/or data that comply with communication standards such as cellular 2G, 3G, 4G or 5G, Institute of Electrical and Electronics Engineers (IEEE) 802.11 standard such as WiFi, IEEE 802.16 standard such as WiMAX, Bluetooth™, or combinations thereof. In addition, the communication elements 26, 56, 64 may utilize communication standards such as ANT, ANT+, Bluetooth™ low energy (BLE), the industrial, scientific, and medical (ISM) band at 2.4 gigahertz (GHz), or the like. Alternatively, or in addition, the communication elements 26, 56, 64 may establish communication through connectors or couplers that receive metal conductor wires or cables, like Cat 6 or coax cable, which are compatible with networking technologies such as ethernet. In certain embodiments, the communication elements 26, 56, 64 may also couple with optical fiber cables. The communication elements 26, 56, 64 may respectively be in communication with the processing elements 22, 52, 60 and/or the memory elements 24, 48, 62.

The memory elements 24, 48, 62 may include electronic hardware data storage components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. In some embodiments, the memory elements 24, 48, 62 may be embedded in, or packaged in the same package as, the processing elements 22, 52, 60. The memory elements 24, 48, 62 may include, or may constitute, a “computer-readable medium.” The memory elements 24, 48, 62 may store the instructions, code, code segments, software, firmware, programs, applications, apps, services, daemons, or the like that are executed by the processing elements 22, 52, 60. In an embodiment, the memory elements 24, 48, 62 respectively store the software applications/program 28, 58, 66. The memory elements 24, 48, 62 may also store settings, data, documents, sound files, photographs, movies, images, databases, and the like.

The processing elements 22, 52, 60 may include electronic hardware components such as processors. The processing elements 22, 52, 60 may include digital processing unit(s). The processing elements 22, 52, 60 may include microprocessors (single-core and multi-core), microcontrollers, digital signal processors (DSPs), field-programmable gate arrays (FPGAs), analog and/or digital application-specific integrated circuits (ASICs), or the like, or combinations thereof. The processing elements 22, 52, 60 may generally execute, process, or run instructions, code, code segments, software, firmware, programs, applications, apps, processes, services, daemons, or the like. For instance, the processing elements 22, 52, 60 may respectively execute the software applications/programs 28, 58, 66. The processing elements 22, 52, 60 may also include hardware components such as finite-state machines, sequential and combinational logic, and other electronic circuits that can perform the functions necessary for the operation of the current invention. The processing elements 22, 52, 60 may be in communication with the other electronic components through serial or parallel links that include universal busses, address busses, data busses, control lines, and the like.

Data sources hosted by any of the computing devices of the environment 10 may utilize a variety of formats and structures within the scope of the invention. For instance, relational databases and/or object-oriented databases may embody the data sources, and may be exposed for queries by one or more corresponding application programming interfaces (APIs). One of ordinary skill will appreciate that-while examples presented herein may discuss specific types of operating systems and/or databases-a wide variety may be used alone or in combination within the scope of the present invention.

In a preferred embodiment, self-referential learning outputs of embodiments of the present invention, such as policies described in more detail below, are stored in a distributed digital ledger and/or blockchain. For example, any of the computing devices of the environment 10 may host, manage and/or store one or more of a trustless triple-entry-bookkeeping system, distributed digital ledger and/or blockchain. In one or more embodiments, the trustless triple-entry-bookkeeping system, distributed digital ledger and/or blockchain maintained according to the description herein may comprise a decentralized database shared and synchronized across multiple devices, permitting sharing of and visibility into the database's contents across multiple devices and individuals. In one or more embodiments, the multiple devices and individuals share an identical copy of the database. Changes and additions to the contents of the database are also distributed to the multiple devices and individuals sharing the database. In one or more embodiments, embodiments of the present invention may utilize and/or comprise databases constructed, configured and/or maintained according to blockchain technology, with lists of records or blocks being securely linked together with cryptographic hashes and commonly including a Merkle tree in which data nodes comprise leaves thereof. However, one of ordinary skill will appreciate that a variety of decentralized database types are within the scope of the present invention.

In one or more embodiments, the contents of the database and/or identifiers therefore are hashed and stored as Turing Interaction Entries (TIEs). The hashed TIEs accordingly represent the outputs (e.g., policies) in a manner that preferably avoids collisions or duplicative operations on digital interactions. More particularly, embodiments of the present invention utilize TIEs to avoid duplicative self-referential learning operations in which the same digital interaction is accounted for multiple times during learning operations because it is represented multiple times across multiple disparate entries in the database (e.g., for financial transactions, because the same digital interaction was reported by multiple different financial service providers).

In a preferred embodiment, the program 66 of the service device 16 is configured to automatically: classify input signals in one or more use cases having corresponding value functions; generate a value function for each input signal; compare the generated value function against stored value functions corresponding to previous digital interactions of the same use case; produce outputs such as policies encoding self-referential learning through evaluation of the present value function against the stored value functions; identify a preferred value for one or more parameters of the digital interaction through the self-referential learning; and store the outputs and/or policies embodying the learning for future use (e.g., in a distributed digital ledger, thereby reducing the chances of collision between entries). The preferred value may be used for automated decisioning in connection with a subsequent digital interactions, including those with the same, similar or different use case(s). More detailed discussion of embodiments of the present invention is below.

Through hardware, software, firmware, or various combinations thereof, the processing elements 22, 52, 60 may—alone or in combination with other processing elements—be configured to perform the operations of embodiments of the present invention. Specific embodiments of the technology will now be described in connection with the attached drawing figures. The embodiments are intended to describe aspects of the invention in sufficient detail to enable those skilled in the art to practice the invention. Other embodiments can be utilized and changes can be made without departing from the scope of the present invention. The system may include additional, less, or alternate functionality and/or device(s), including those discussed elsewhere herein. The following detailed description is, therefore, not to be taken in a limiting sense. The scope of the present invention is defined only by the appended claims, along with the full scope of equivalents to which such claims are entitled, unless otherwise expressly stated and/or readily apparent to those skilled in the art from the description.

### Exemplary Computer-Implemented Method for Digital Interaction Optimization

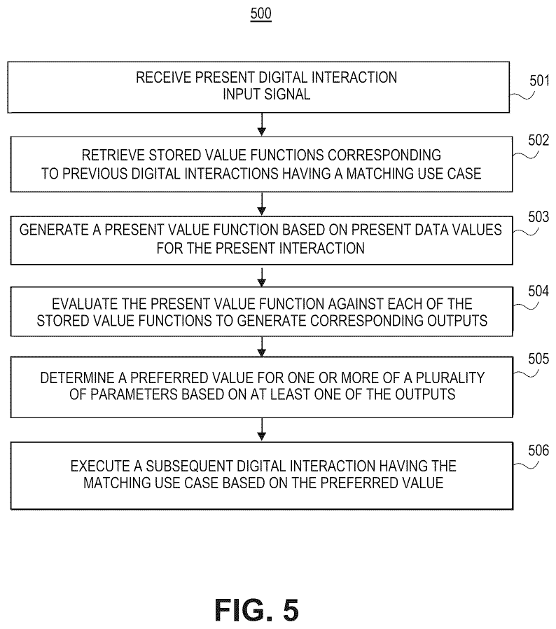

FIG. 5 depicts a flowchart including a listing of steps of an exemplary computer-implemented method 500 for computationally efficient, high dimensionality digital interaction optimization. The steps may be performed in the order shown in FIG. 5, or they may be performed in a different order. Furthermore, some steps may be performed concurrently as opposed to sequentially. In addition, some steps may be optional.

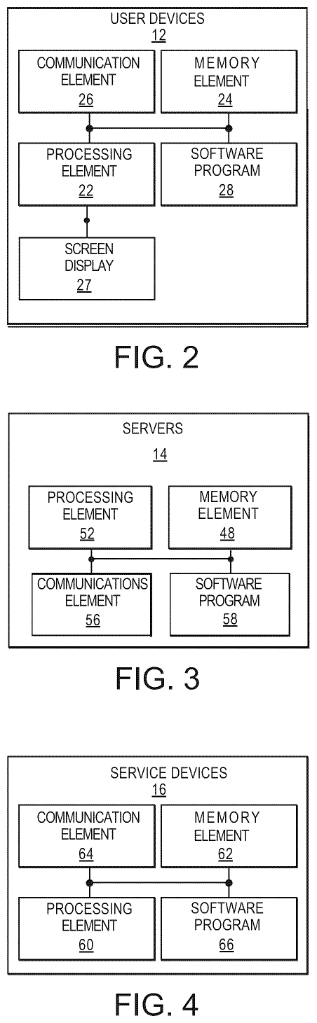

The computer-implemented method 500 is described below, for ease of reference, as being executed by exemplary devices and components introduced with the embodiments illustrated in FIGS. 1-4. For example, the steps of the computer-implemented method 500 may be performed by the user devices 12, the servers 14, the service device 16 and the network 20 through the utilization of processors, transceivers, hardware, software, firmware, or combinations thereof. However, a person having ordinary skill will appreciate that responsibility for all or some of such actions may be distributed differently among such devices or other computing devices without departing from the spirit of the present invention. One or more computer-readable medium(s) may also be provided. The computer-readable medium(s) may include one or more executable programs stored thereon, wherein the program(s) instruct one or more processing elements to perform all or certain of the steps outlined herein. The program(s) stored on the computer-readable medium(s) may instruct the processing element(s) to perform additional, fewer, or alternative actions, including those discussed elsewhere herein.

Referring to operation 501, a present digital interaction input signal may be received. The input signal may be received by a service device (e.g., service device 16) configured for self-referential learning via evaluation of value functions, enabling automatic and computationally efficient digital interaction parameter optimization.

For example, the input signal may comprise or embody a message including data regarding a putative, potential or completed financial transaction, the message being captured at any stage of a financial transaction (e.g., as described in preceding sections of this disclosure). The data may include a plurality of values for a plurality of corresponding parameters of a financial transaction. In one or more embodiments, the parameters may include data types such as parties or entities involved in the transaction. The parties or entities may include, without limitation, payer (e.g., cardholder or account owner), payee (e.g., merchant), any or all entities comprising a payment network, internet service provider, cellular network and/or service provider, email service provider, cardholder device manufacturer, digital wallet service provider, financial service provider such as open banking service provider, or any other actor, contributor to, or participant in the digital interaction.

The parameters may also include other actions or states relating to the digital interaction such as payment amount, account balance, payment rail or method, geographic location(s), geographic region(s), currency type(s), transaction type, merchant category code, open banking states and/or permissions (for example, regulatory and contractual permissions, permissions with identity, and/or consent and access controls such as role-based (rbac), attribute-based (abac), policy-based (pbac) and experience-based (ebac)), ownership (for example, as it relates regulatory and contractual aspects, production, distribution, exchange, consumption and/or observational ownership, such as in connection with economic and intrinsic value where possession and control is determined and managed), details regarding payment routing or signal routing and processing within a payment network, or any other discoverable or derivable aspect or variable that may relate to the interaction. In one or more embodiments, such permission parameters may be incorporated into the corresponding policy frame(s). Advantageously, such permission parameters and their corresponding incorporation into frame(s) may enable a degree of control by agents over what is used in a system and may provide initial value functions and policies, e.g., through API requests, user settings, smart contracts or the like.

It is again noted, however, that other digital interactions—e.g., social media digital interactions—are also within the scope of the present invention, and the plurality of parameters may accordingly encompass a variety of other parameters relating to corresponding entities and actions and states for the entities.

Referring to operation 502, stored value functions corresponding to previous digital interactions having matching use cases may be retrieved. The stored value functions may be retrieved by the service device (e.g., service device 16) from a database stored or hosted by the service device and/or from one or more other computing devices (e.g., servers and user devices 14, 12). The database may be of any type, but is preferably a distributed digital ledger.

Stored value functions may be expressed in terms of tensors and/or vectors comprising values for a plurality of parameters. The parameters may correspond to actions and states for agents or entities involved in the digital interaction. A stored value function may also include or be evaluated with an objective function. The objective function may provide or comprise statistics or basic analytics relating to the use case at issue, and may comprise a subset of the parameters representing or embodying a metric or method for automatically determining whether an action or state change for an entity having an initial state is favorable or preferred.

In a simple example, a bill payment use case may have a corresponding value function including parameters relating to the payment, and an objective function defining completion of the payment as favorable and non-completion as unfavorable. The value function may be evaluated in view of or with the objective function to determine a relationship between one or more of the parameters and a change in favorability attributable to a change in the one or more parameters. The evaluation may generate output(s) that enable determination of a preferred value and subsequent optimized digital interactions (e.g., payment(s)), as discussed in more detail below.

In a more particular example, in one or more embodiments the stored value functions comprise policies embodying or encoding Hamiltonian value functions. A Hamiltonian is a value function defining a system with, for example, a set of first order partial differential equations including the parameters received with the input signal. The Hamiltonian is configured to define the full set of parameters (actions and states for entities) for the value function and to include an objective function. The objective function defines the relationships required for the policy to apply a value or an expected return (e.g., with reference to a reward or cost/risk) to mappings between each state and action and the probability of taking a given action when in a given state. Evaluation of the Hamiltonian generates the policy, representing the expected value (according to the objective function or “frame”) of an entity in a state taking one of the actions according to the policy. Roughly stated, whether and to what extent the entity's action or state change was “good” in the system defined by the Hamiltonian is evaluated according to the objective function and the output or policy reflects both this learning and the Hamiltonian itself. It should be noted that the policy may express the degree of favorability in raw terms or as a scaled score, such as where the probability of a successful payment is expressed according to the objective function on a scale from 0 to 1.

Hamiltonian policies represent a preferred vehicle for self-referential or reinforcement learning according to embodiments of the present invention, whereby the service device may automatically and computationally efficiently learn correlations within each given use case and according to each frame of a Hamiltonian. A representation of such a policy is p=μ(^ H, F), where p is the policy, μ represents the use case, ^H represents the Hamiltonian, and F represents the frame.

It should be noted that retrieval of the stored value functions may include matching a use case reflected by the input signal to that of the stored value functions. In one or more embodiments, the use case is represented by a subset of the parameters having values embedded in the input signal. For example, the use case may be “utility bill payment” or a particular type of “open banking financial transaction,” respectively as encoded by the presence of values and/or structured data labels included in the input signal indicating that the input signal relates to one or both of these. Accordingly, the service device may classify or extract the use case parameter(s) from the input signal and retrieve the corresponding store value functions having the matching use case(s) (e.g., “utility bill payment”).

It should be noted that an input signal may be matched to multiple use cases, such as where there are multiple vertical tiers of use cases (e.g., “payment,” “bill payment,” and “utility bill payment”) and/or where there are multiple different aspects of the input signal considered in discrete self-referential learning operations (e.g., “water utility bill payments,” “utility bill payments in the Midwest,” “utility bill payments via irregular payment methods” or the like).

Referring to operation 503, a present value function may be generated based on present data values for the present digital interaction. The present value function may be generated by the service device (e.g., service device 16) and/or by another computing device. For example, in one or more embodiments, the present value function is generated by a service device of a payment network supporting automated decisioning relating to financial transactions such as the present digital interaction.

The present value function may be generated according to a template stored by the service device, such as where the use case and corresponding objective function are associated with one or more value function templates defining and used to generate the present value function and stored value functions. It is foreseen that a database storing a plurality of such templates—for the present use case and one or more objective functions or frames, and optionally for a plurality of other use cases and corresponding objective function(s) or frame(s)—may be maintained or accessed by the service device within the scope of the present invention.

However, in one or more embodiments, the service device may determine the composition and definition of the present value function merely with reference to the retrieved stored value functions or data representations thereof, within the scope of the present invention. Put differently, in one or more embodiments, the use cases are self-defined according to degree of similarity between various input signals, with the required degree of similarity optionally being governed by one or more rules of higher abstraction (e.g., where threshold similarity is defined according to parameter or variable type, such as in a weighted summation across the plurality of parameters in the input signal).

Generation of the present value function may include extracting values for the plurality of parameters of the present value function from the input signal, for example according to the corresponding template. Generation of the present value function may also include generating, retrieving or deriving additional values for the value function that are not present in the input signal. For example, in one or more embodiments, values to be included in the present value function may be retrieved from a database (e.g., an internal or third party database) via API call, and/or may be derived through computations relying on one or more of the extracted or retrieved values discussed herein. The present value function may be generated from the extracted, retrieved and/or calculated values based on the corresponding use case and objective function template and/or one or more of the stored value functions. For example, in one or more embodiments, values for a parameter extracted from, and optionally averaged across, stored value functions may be imputed to the present value function within the scope of the present invention.

In the preferred embodiment, the present value function is a Hamiltonian generated for the use case, and using the frame, represented in the retrieved stored value functions. However, it is foreseen that the present value function may incorporate tensors and/or vectors, or other mathematical functions, including the parameters relating to the digital interaction, within the scope of the present invention.

Referring to operation 504, the present value function may be evaluated against each of the stored value functions to generate corresponding outputs. The evaluation may be performed by the service device (e.g., service device 16) and/or by another computing device.

The evaluation may determine one or more differences between the parameters of the value function and each corresponding one of the stored value functions and output a representation of whether the difference was favorable or unfavorable according to the objective function. The output may encode whether and to what extent evaluation of the objective function determined the difference as having progressed the system represented by the value functions toward, or receded the system from, the goal encoded thereby. The output may additionally include the value function(s) or a representation thereof.

In the preferred embodiment, the Hamiltonian comprising the present value function is evaluated against each Hamiltonian having the matching use case and frame of the stored value functions. For example, the difference in one or more of the state and action variables is thereby associated with a value or reward according to the objective function or frame of the Hamiltonians and expressed as an output comprising a policy.

The stored value functions and the present value function may be associated with a single continuous completed or attempted “transaction” or series of events or with multiple transactions or series of events. For example, a digital interaction signaled by an input signal may be a time sliver for an event, where the stored value functions and the present value function are associated with multiple such slivers of the same event or transaction. The event may be a putative or completed transaction, with each respective value function embodying the values for the parameters at various times or states throughout the event. In this way, evaluation of the value functions may result in outputs describing movement of the system represented by the value functions in the form of progression toward or regression from a goal embodied by the objective function (or frame) over time for a single transaction or event. However, in one or more embodiments, the stored value functions and present value function may be stateless with respect to time and/or ordering of an event or event(s) without departing from the spirit of the present invention. Again, the goal and objective function may encode the total sum of the risks, costs, loss functions and rewards of the total sum of the minima and maxima of risks, costs and loss functions known for and accounted for in the value functions for the given use case.

In the more specific example treated throughout this disclosure, the stored Hamiltonians and the present Hamiltonian may together be associated with a single attempted bill pay event. Such an event may begin with an account owner indicating on a user device a desire to process a payment for a local power company. Both may be considered entities or agents within the Hamiltonians describing the system. The use case may accordingly correspond to a utility bill payment and, in one or more embodiments, more specifically to a utility bill payment for power. The account owner may select a hyperlink embedded in an email message to “pay bill,” causing a corresponding web browser selection and inclusion of the web browser provider as an entity or agent within the system's Hamiltonian. Moreover, an internet service provider supporting these operations may be added as an entity or agent, along with a manufacturer of the user device. The account owner may also log in for bill payment using a cellular service, causing addition of the corresponding telecommunications provider as an entity or agent.

At each step in the account selection and payment rail process that follows, multiple entities or agents of the corresponding payment network(s) and/or related financial service providers may be added as entities or agents. In one or more embodiments, existing automated decisioning provided by one or more such financial service providers may also be involved in the process. For example, the services offered under PAYMENT SUCCESS INDICATOR™ and/or PAYMENT ROUTING OPTIMIZER™ by Mastercard International Incorporated and/or affiliated entities may provide automated decisioning relating to the attempted payment and its success (along with recommended payment rails, dates of payment or the like), which may cause incorporation of the corresponding provider(s) to be incorporated as entities or agents in the value function(s). Such automated decisioning processes may rely on one or more values for parameters included in the value functions to support approval, denial and/or routing of the payment.

The account owner may complete the transaction, for example according to the recommendations and automated decisioning or other operations described above. The account owner may receive confirmation of the completed transaction.

The stored and present value functions may respectively capture the parameters comprising actions and states for the variety of involved entities and agents at various moments in the progression, and the outputs may be policies reflecting transition between the present and respective stored value functions during or following the successful completed transaction. In this example, the successful completion may be the metric for progression embodied by the corresponding frame or objective function, and the evaluation may relate the various states and actions of the entities (i.e., parameters describing the system) to the successful completion in a form of self-referential learning.

However, it should be noted that other objective functions and value functions may alternatively or additionally be pursued, for example where fraud prevention, software and device functionality, observation, or other forms of payment processing are to be optimized according to the self-referential learning processes described herein.

Further, and despite the example provided above being related to a single payment transaction, it should also be noted that the stored value functions and the present value function may also or alternatively be associated with different events, such as multiple bill payment events across one or more payors, without departing from the spirit of the present invention. The present value function for the present payor system may be evaluated against the stored value functions for systems for the present payor in previous payments and/or for systems of other payors in previous payments.

Moreover, where the stored functions are stored in and retrieved from a distributed digital ledger, or otherwise associated with or comprise hash identifiers, it is foreseen that duplicative evaluations of the present value function against multiple stored value functions representing the same previous digital interaction may be advantageously avoided. It should also be noted that the outputs (and, in the case of Hamiltonian value functions, policies) of the evaluation are preferably stored in the distributed digital ledger as TIEs, for the reasons discussed above and for use in future evaluations.

Moreover, it should be noted that storage of the output(s) or policy(ies) may be contingent on determination that one or more values for the plurality of parameters are different as between the present and stored value function under evaluation. That is, where the values for the parameters are the same, the corresponding output of the evaluation may not be stored. For example, where the values for a subset of the parameters, such as all or some of those corresponding to the frame of a Hamiltonian, are the same as between the present value function and one of the stored value functions, the corresponding output of an evaluation may not be stored, which may relieve storage burden(s) and/or improve computational efficiency in cases where insufficient differences between the value functions are present to yield useful outputs. Conversely, a difference found between the values for one or more such parameters may trigger storage of the output or policy.

Referring to operation 505, the outputs of the evaluations (e.g., policies) may be used to determine a preferred value for one or more of the plurality of parameters embodied by the value functions. The determination may be made by the service device (e.g., service device 16) and/or by another computing device.

Because the evaluation of the value functions described above yields outputs implicitly or explicitly relating changes in entity states and actions (parameter values) to movement toward or away from goals (e.g., risks, costs, rewards), as determined based on an objective function, the self-referential learning may be applied to determine a preferred or optimized value for one or more of those parameters. The determination of this correlation through the value function evaluation may itself be considered identification of a preferred value for the correlated change in entity states or actions.

However, one or more embodiments, including those examples discussed below, provide for more comprehensive training on multiple such outputs or policies to yield the preferred value. For example, the outputs (such as policies, in the case of Hamiltonian value functions) may be input to one or more machine learning models to support machine learning and consequent identification of the preferred value.

The service device may input the outputs or policies to machine learning models or algorithms to develop correlations between parameters of the value functions and progress toward or away from the goal(s) embodied or defined in the objective function and/or other system goal(s). In embodiments using collision free storage and/or hashed TIE entries in a distributed digital ledger, duplicative outputs—e.g., as determined by comparing the hashed identifier(s) and/or entry(ies)—may not be fed as training data to the machine learning model(s).

The machine learning program(s) of the service device may therefore recognize or determine correlations between parameter value(s) on the one hand, and preferred outcomes or characteristics of the digital interactions on the other hand. The preferred outcomes may be with reference to any one or more of the entities or agents represented in the value functions.

The machine learning techniques or programs may include curve fitting, regression model builders, convolutional or deep learning neural networks, combined deep learning, pattern recognition, classification, clustering, dimensionality reduction (feature selection, feature extraction), decision trees, attention, or the like. Based upon this data analysis, the machine learning program(s) may learn method(s) for executing the digital interactions to optimize toward certain goals.

It should be noted that, in supervised machine learning, the program may be provided with example inputs (i.e., parameter values) and their associated outputs (i.e., policies), and may seek to discover a general rule that maps inputs to outputs for improved execution of digital interactions. In unsupervised machine learning, the program may be required to find its own structure in unlabeled example inputs.

The program may utilize classification algorithms such as Bayesian classifiers and decision trees, sets of pre-determined rules, and/or other algorithms.

In one or more embodiments, where the payment example discussed above is concerned, the preferred value may be identified by the machine learning models powering one or both of the services offered under PAYMENT SUCCESS INDICATOR™ and/or PAYMENT ROUTING OPTIMIZER™. For example, in one or more embodiments, the outputs or policies are submitted as training data to the machine learning model(s), with the trained models determining the preferred value which, in turn, may be an optimized value for one or more transaction parameters for the payment. The preferred value may also or alternatively be an optimized value for one or more transaction parameters for an open banking transaction.

Referring to operation 506, a subsequent digital interaction having the matching use case may be executed based on the preferred value. In one or more embodiments, the preferred value and/or training machine learning model may be implemented by the service device (e.g., service device 16) and/or transmitted to another computing device for execution of the subsequent digital interaction based thereon.

In the payment example discussed in more detail above, the preferred value may be one of an optimized payment rail value and optimized a date for payment of the utility bill. The services offered under PAYMENT SUCCESS INDICATOR™ and/or PAYMENT ROUTING OPTIMIZER™ may process the subsequent digital interaction comprising the subsequent bill payment using the preferred value.

It should be reiterated that a central goal of embodiments of the present invention is to provide a technological mechanism for computationally efficient digital interaction capture in high dimensional spaces and, more particularly, to systems and methods for performing such capture to support model analyses. Embodiments of the present invention implement technological mechanisms for self-referential learning. Embodiments also provide for improved, efficient capture of granular, low-level interaction data and self-learning supporting automated decisioning without prohibitive computational constraints.

Preferred embodiments utilize Hamiltonian value functions for self-referential learning to promote efficient capture of relationships at granular levels of detail through enabling simple set difference and symmetric difference operations for abstracted representations of data. For example, in one or more embodiments, outputs or policies stored according to and/or embodying such Hamiltonians may be compared one to another, across multiple use cases and/or in a Hilbert Space, and/or fed as input to machine learning models for optimization of one or more digital interaction parameters.

Moreover, embodiments of the present invention comprise a decentralized database shared and synchronized across multiple devices, permitting sharing of and visibility into the database's contents across multiple devices and individuals. In one or more embodiments, the contents of the database and/or identifiers therefore are hashed and stored as TIEs. The hashed TIEs accordingly represent the outputs (e.g., policies) in a manner that preferably avoids collisions or duplicative operations on digital interactions. More particularly, embodiments of the present invention utilize TIEs to avoid duplicative self-referential learning operations in which the same digital interaction is accounted for multiple times during learning operations because it is represented multiple times across multiple disparate entries in the database (e.g., for financial transactions, because the same digital interaction was reported by multiple different financial service providers).

The method may include additional, less, or alternate steps and/or device(s), including those discussed elsewhere herein, unless otherwise expressly stated and/or readily apparent to those skilled in the art from the description.

### Additional Considerations

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein, unless otherwise expressly stated and/or readily apparent to those skilled in the art from the description.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The patent claims at the end of this patent application are not intended to be construed under 35 U.S.C. § 112(f) unless traditional means-plus-function language is expressly recited, such as “means for”or “step for”language being explicitly recited in the claim(s).

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. Non-transitory computer-readable storage media having computer-executable instructions stored thereon for digital interaction optimization, wherein when executed by at least one processor the computer-executable instructions cause the at least one processor to:
receive an input signal for a present digital interaction;
retrieve stored value functions corresponding to previous digital interactions having a matching use case to the present digital interaction, each of the stored value functions including stored data values for a plurality of parameters;
generate a present value function corresponding to the matching use case based at least in part on present data values for the plurality of parameters, the present data values being extracted from the input signal, each of the present and stored value functions being a Hamiltonian value function and including an objective function comprising a frame, with the frame comprising a subset of the plurality of parameters and the subset defining one or more of a risk, a reward or a cost;
evaluate the present value function against each of the stored value functions to generate corresponding outputs, the outputs respectively corresponding to one or more of an increase in the reward or a decrease in the risk or the cost, and the outputs respectively being determined via the objective function resulting from a difference between one or more of the stored data values of the corresponding stored value function and the corresponding one or more present data values of the input signal;
store at least one of the outputs in a policy;
determine, based on at least one of the outputs, a preferred value for one or more of the plurality of parameters; and
execute a subsequent digital interaction having the matching use case based on the preferred value.

2. The non-transitory computer-readable storage media of claim 1, wherein the matching use case is determined by matching at least some of the plurality of parameters to the input signal.

3. The non-transitory computer-readable storage media of claim 1, wherein,
the storage of the at least one of the outputs is contingent on a determination of a difference between the present value function and the corresponding one of the stored value functions.

4. The non-transitory computer-readable storage media of claim 3, wherein
the difference is within the subset.

5. (canceled)

6. (canceled)

7. The non-transitory computer-readable storage media of claim 1, wherein
generating the present value function includes one or both of making an application programming interface call for, and computing a derived value for, at least one of the plurality of parameters for which a value was omitted from the input signal.

8. The non-transitory computer-readable storage media of claim 7, wherein the computation of the omitted value includes retrieval of a corresponding value from one or more of the stored value functions.

9. The non-transitory computer-readable storage media of claim 1, wherein the matching use case is at least one of a bill payment and an open banking financial transaction.

10. The non-transitory computer-readable storage media of claim 9, wherein the preferred value is an optimized transaction parameter for the at least one of a bill payment and an open banking financial transaction.

11. The non-transitory computer-readable storage media of claim 10, wherein the optimized transaction parameter is determined by feeding the outputs to a machine learning model.

12. The non-transitory computer-readable storage media of claim 1, wherein, when executed by the at least one processor, the computer-executable instructions further instruct the at least one processor to store the outputs in a distributed digital ledger.

13. The non-transitory computer-readable storage media of claim 12, wherein
storing the outputs includes generating a hash comprising or as an identifier for each of the outputs,
determining the preferred value includes feeding the outputs to a machine learning model, excluding any output for any of the stored value functions with a duplicative hash.

14. A computer-implemented method for digital interaction optimization comprising, via one or more transceivers and/or processors:
receiving an input signal for a present digital interaction;
retrieving stored value functions corresponding to previous digital interactions having a matching use case to the present digital interaction, each of the stored value functions including stored data values for a plurality of parameters;
generating a present value function corresponding to the matching use case based at least in part on present data values for the plurality of parameters, the present data values being extracted from the input signal, each of the present and stored value functions being a Hamiltonian value function and including an objective function comprising a frame, with the frame comprising a subset of the plurality of parameters and the subset defining one or more of a risk, a reward or a cost;
evaluating the present value function against each of the stored value functions to generate corresponding outputs, the outputs respectively corresponding to one or more of an increase in the reward or a decrease in the risk or the cost, and the outputs respectively being determined via the objective function resulting from a difference between one or more of the stored data values of the corresponding stored value function and the corresponding one or more present data values of the input signal;
storing at least one of the outputs in a policy;
determining, based on at least one of the outputs, a preferred value for one or more of the plurality of parameters; and
executing a subsequent digital interaction having the matching use case based on the preferred value.

15. The computer-implemented method of claim 14,
the storing of the at least one of the outputs is contingent on a determination of a difference between the present value function and the corresponding one of the stored value functions.

16. The computer-implemented method of claim 15, wherein the difference is within the subset.

17. (canceled)

18. The computer-implemented method of claim 17, wherein each of the outputs is stored in a policy.

19. The computer-implemented method of claim 14, wherein generating the present value function includes one or both of making an application programming interface call for, and computing a derived value for, at least one of the plurality of parameters for which a value was omitted from the input signal.

20. The computer-implemented method of claim 14, further comprising, via the one or more processors and/or transceivers, storing the outputs in a distributed digital ledger with a corresponding hash identifier.
